(19) United States
(12) Patent Application Publication
(10) Pub. No.: US 2022/0306909 A1
(43) Pub. Date: Sep. 29, 2022

(54) PRESSURE SENSITIVE ADHESIVE ARTICLE

(71) Applicants: Dow Global Technologies LLC, Midland, MI (US); Rohm and Haas Company, Collegeville, PA (US)

(72) Inventors: Saswati Pujari, Collegeville, PA (US); William B. Griffith, Jr., North Wales, PA (US)

(21) Appl. No.: 17/639,975

(22) PCT Filed: Sep. 15, 2020
(86) PCT No.: PCT/US2020/050840

§ 371 Date: Mar. 3, 2022

Related U.S. Application Data
(60) Provisional application No. 62/900,858, filed on Sep. 16, 2019.

(51) Int. Cl. C09J 7/38; C09J 133/06; C08F 2/22; C08F 220/18

(52) U.S. Cl. CPC C09J 7/385; C09J 133/06; C08F 2/22; C08F 220/1808; C09J 2301/208; C09J 2423/00; C09J 2301/412

(57) ABSTRACT

Provided is a pressure sensitive adhesive article comprising (a) a substrate (Sa) (b) in contact with the substrate (Sa), a layer (Lb) of a pressure sensitive composition (Cb) that comprises one or more acrylic polymer (POLb) having Tg of 20° C. or lower, and (c) in contact with the layer (Lb), a layer (Lc) that comprises, (i) one or more acrylic polymer (POLc) having Tg of 20° C. or lower, and (ii) one or more olefin copolymer. Also provided are a method of making the pressure sensitive adhesive article and a bonded article made by using the pressure sensitive adhesive article.

Pressure sensitive adhesives (PSAs) that contain acrylic polymers have many desirable characteristics. For example, they generally have better resistance to chemical reagents and UV light than PSAs made from many other materials. It is often desired to provide an acrylic PSA that bonds well to polyolefin substrates. In the past, sometimes a tackifier compound was added to the PSA to increase the peel adhesion of the PSA to a substrate. However, addition of tackifier normally causes an undesirable reduction in the shear resistance of the PSA.

US 2013/0202855 describes a pressure-sensitive adhesion composition that contains an acrylate polymer or copolymer and also contains a second polymer that may be, for example, an ethylene-acrylic acid copolymer.

It is desired to provide a PSA that contains acrylic polymer and that, when bonded to polyolefin substrates, shows both good peel adhesion and good shear resistance. It is also desired to provide a PSA that contains both an acrylic polymer and an olefin copolymer, where that PSA is designed in a way that obtains the advantages of including olefin copolymer while reducing the use of amounts of olefin copolymer beyond what is needed to obtain the advantages.

The following is a statement of the invention.

A first aspect of the present invention is a pressure sensitive adhesive article comprising
(a) a substrate (Sa)
(b) in contact with the substrate (Sa), a layer (Lb) of a pressure sensitive composition (Cb) that comprises one or more acrylic polymer (POLb) having Tg of 20° C. or lower, and
(c) in contact with the layer (Lb), a layer (Lc) that comprises, by weight based on the weight of the layer (Lc),
   (i) 60% to 99.5% one or more acrylic polymer (POLc) having Tg of 20° C. or lower, and
   (ii) 0.5% to 40% one or more olefin copolymer.

A second aspect of the present invention is a method of making the pressure sensitive article of the first aspect, wherein the method comprises,
(A) forming a layer of an aqueous composition (Qb) that contains dispersed particles of the acrylic polymer (POLb) on a first surface,
(B) forming a layer of an aqueous composition (Qc) that contains dispersed particles that contain (i) the acrylic polymer (POLc) and (ii) the olefin copolymer on a second surface,
(C) drying the layer of the aqueous composition (Qb) to form the layer (Lb), and
(D) drying the layer of the aqueous composition (Qc) to form the layer (Lc).

A third aspect of the present invention is a bonded article made by a process of contacting a substrate (Sd) with the article of the first aspect, wherein the substrate (Sd) is in contact with the layer (Lc).

The following is a brief description of the drawings.

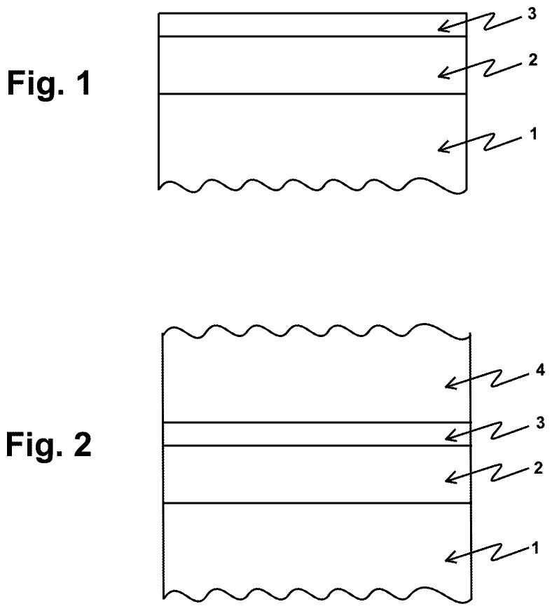

FIG. 1 is a vertical cross section of a pressure sensitive adhesive article of the present invention showing substrate (Sa) (1); layer (Lb) (2) of a composition (Cb), which contains one or more acrylic polymer (POLb) having Tg of 20° C. or lower; and layer (Lc) (3) of a composition (Cc), which contains polymer (POLc) and olefin copolymer. FIG. 1 is not drawn to scale in any sense. For example, the size of the pressure sensitive adhesive article of the present invention in the horizontal direction shown in FIG. 1 may be larger by a factor of 1,000 or more than the size in the vertical direction shown in FIG. 1.

FIG. 2 (also not drawn to scale) depicts a preferred use to which the pressure sensitive adhesive article of the present invention may be put. FIG. 2 shows layer (Lc) (3) in contact with an additional substrate (Sd) (4).

The following is a detailed description of the invention.

As used herein, the following terms have the designated definitions, unless the context clearly indicates otherwise.

As used herein, Dynamic Mechanical Analysis (DMA) refers to measurements made in shear geometry in the linear viscoelastic range at frequency of 1 sec⁻¹. DMA measures the elastic modulus (G′), the loss modulus (G″), and tan delta (the quotient found by dividing G″ by G′, synonymously called “tan (δ)”). A curve showing tan delta as a function of temperature is known herein as a “tan delta curve.” Elastic modulus is reported herein in units of kilopascals (kPa).

The glass transition temperature (Tg) of a material is determined by differential scanning calorimetry using the midpoint method and temperature scan rate of 10° C. per minute according to test method ASTM D7426-08 (American Society of Testing and Materials, Conshohocken, Pa., USA).

A “polymer,” as used herein is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. The size of polymers is characterized by Mw, the weight-average molecular weight, as measured by size exclusion chromatography.

As used herein “weight of polymer” means the dry weight of polymer.

Molecules that can react with each other to form the repeat units of a polymer are known herein as “monomers.” The repeat units so formed are known herein as “polymerized units” of the monomer.

Vinyl monomers have the structure

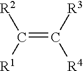

where each of R¹, R², R³, and R⁴ is, independently, a hydrogen, a halogen, an aliphatic group (such as, for example, an alkyl group), a substituted aliphatic group, an aryl group, a substituted aryl group, another substituted or unsubstituted organic group, or any combination thereof.

Some suitable vinyl monomers include, for example, styrene, substituted styrenes, dienes, ethylene, other alkenes, dienes, ethylene derivatives, and mixtures thereof. Ethylene derivatives include, for example, unsubstituted or substituted versions of the following: ethenyl esters of substituted or unsubstituted alkanoic acids (including, for example, vinyl acetate and vinyl neodecanoate), acrylonitrile, (meth)acrylic acid, (meth)acrylates, (meth)acrylamides, vinyl chloride, halogenated alkenes, and mixtures thereof. As used herein, “(meth)acrylic” means acrylic or methacrylic; “(meth)acrylate” means acrylate or methacrylate; and “(meth)acrylamide” means acrylamide or methacrylamide. “Substituted” means having at least one attached chemical group such as, for example, alkyl group, alkenyl group, vinyl group, hydroxyl group, carboxylic acid group, other functional groups, and combinations thereof. In some embodiments, substituted monomers include, for example, monomers with more than one carbon-carbon double bond, monomers with hydroxyl groups, monomers with other functional groups, and monomers with combinations of functional groups. (Meth)acrylates are substituted and unsubstituted esters or amides of (meth)acrylic acid.

As used herein, acrylic monomers are monomers selected from (meth)acrylic acid, aliphatic esters of (meth)acrylic acid, aliphatic esters of (meth)acrylic acid having one or more substituent on the aliphatic group, (meth)acrylamide, N-substituted (meth)acrylamide, and mixtures thereof.

As used herein, vinylaromatic monomers are monomers selected from styrene, alpha-alkyl styrenes, other substituted styrenes, and mixtures thereof.

As used herein, an “acrylic” polymer is a polymer in which 50% or more of the polymerized units are acrylic monomers, and also in which 70% or more of the polymerized units are either acrylic monomers or vinylaromatic monomers. The percentages are by weight based on the weight of the polymer.

As used herein, an olefin polymer is a polymer in which 60% or more, or 70% or more of the polymerized monomer units by weight, based on the weight of the olefin polymer, are selected from hydrocarbon alkenes, hydrocarbon dienes, and mixtures thereof, by weight based on the weight of the polymer. An olefin copolymer is an olefin polymer in which one or more of the polymerized units are polymerized units of one or more monomers (called “comonomers”) that contain one or more oxygen atom per molecule. An ethylene copolymer is an olefin copolymer in which 60% or more, or 70% or more by weight, based on the weight of the polymer, of the polymerized units are polymerized units of ethylene. A propylene copolymer is an olefin copolymer in which 70% or more by weight, based on the weight of the polymer, of the polymerized units are polymerized units of propylene.

A tackifier is an organic compound having molecular weight of 300 to 10,000 and having glass transition temperature of 0° C. or higher.

A Pressure Sensitive Adhesive (PSA) is an adhesive that forms a bond with a substrate when pressure is applied to bring the adhesive and the substrate into contact. The bond forms without addition of further materials or the application of heat. As used herein, a pressure sensitive adhesive article is an article in which a pressure sensitive adhesive is adhered to a first substrate and in which a surface of the PSA (the “available surface”) is available to make contact with a second substrate. The available surface of the PSA may or may not be in contact with a release material. A release material is a material that forms a weak bond with the PSA and may be easily removed so that the available surface is exposed.

A composition is herein considered to be “aqueous” if the composition contains water in the amount of 25% or more by weight based on the weight of the composition.

A particle that is not spherical is considered herein to have diameter D, where a sphere of diameter D has the same volume as the particle. Particles are said herein to be dispersed in a liquid medium if the particles are distributed throughout the liquid medium; dispersed particles may form an emulsion, a latex, a dispersion, a slurry, or some other composition in which particles are dispersed in a liquid medium. A liquid medium is considered herein to be an aqueous medium if water forms 50% or more by weight of the liquid medium (disregarding the weight of the dispersed particles).

When it is stated herein that an aqueous composition is dried, it is meant that the composition is either allowed to dry under ambient conditions or is dried by the application of heat, exposure to moving gas (which may or may not be heated), or a combination thereof.

Ratios presented herein are characterized as follows. For example, if a ratio is said to be 3:1 or greater, that ratio may be 3:1 or 5:1 or 100:1 but may not be 2:1. This characterization may be stated in general terms as follows. When a ratio is said herein to be X:1 or greater, it is meant that the ratio is Y:1, where Y is greater than or equal to X. For another example, if a ratio is said to be 15:1 or less, that ratio may be 15:1 or 10:1 or 0.1:1 but may not be 20:1. In general terms, when a ratio is said herein to be W:1 or less, it is meant that the ratio is Z:1, where Z is less than or equal to W.

The present invention involves the use of a substrate, herein labeled substrate (Sa). The substrate (Sa) may be any material. Preferred are paper, polymer film, and metal foil. Among polymer films, preferred are polyester films and olefin polymer films. Among polymer films, preferred are those in which at least one side has been treated by corona discharge.

In contact with substrate (Sa) is a layer of a composition, herein referred to as composition (Cb). Composition (Cb) contains one or more polymer, herein referred to as polymer (POLb). Polymer (POLb) has Tg of 20° C. or lower; preferably 10° C. or lower. Preferably polymer (POLb) has Tg of −100° C. or higher.

Preferably, composition (Cb) has little or no tackifier. That is, the amount of tackifier in composition (Cb) is, by weight based on the dry weight of composition (Cb), less than 10%; more preferably 3% or less; more preferably 1% or less; more preferably zero.

Preferably, polymer (POLb) is an acrylic polymer. Preferably, the amount of polymerized units of acrylic monomers in polymer (POLb) is, by weight based on the weight of polymer (POLb), 50% or more; more preferably 70% or more; more preferably 90% or more; more preferably 99% or more. Preferably, polymer (POLb) has Mw of 10,000 or higher; more preferably 50,000 or higher.

Preferably, polymer (POLb) contains polymerized units of one or more of n-butyl acrylate (n-BA), ethyl acrylate (EA), isooctyl acrylate (i-OA), or a mixture thereof. As used herein, “isooctyl” is an unsubstituted alkyl group that contains exactly 8 carbon atoms in a branched configuration. The term “isooctyl” includes all branched isomers of 8-carbon alkyl groups and all mixtures of such isomers, including, for example, the 2-ethylhexyl group, dimethyl-hexyl groups, methyl-heptyl groups, trimethyl-pentyl, and mixtures thereof. Preferably, the sum of the amounts of polymerized units of n-BA, polymerized units of EA, and polymerized units of i-OA in polymer (POLb), by weight based on the weight of polymer (POLb), is 50% or more; more preferably 75% or more; more preferably 90% or more.

Preferably, every polymer in composition (Cb) that has Mw of 10,000 or higher is an acrylic polymer.

Preferably, the amount of polymer (POLb) in composition (Cb), by weight based on the dry weight of composition (Cb), is 80% or more; more preferably 90% or more; more preferably 95% or more.

Preferably, composition (Cb) has the properties of a PSA. Preferably, composition (Cb) has elastic modulus (G′) of 20 kPa or higher over a temperature range that includes the range of 10° C. to 40° C. Preferably, composition (Cb) has elastic modulus (G′) over a temperature range that includes the range of 10° C. to 40° C. of 1,000 kPa or lower; more preferably 500 kPa or lower.

Preferably, composition (Cb) is in contact with a surface of substrate (Sa) that has been treated by corona discharge.

A layer (Lc) of composition (Cc) is in contact with the layer (Lb) of composition (Cb). Composition (Cc) contains one or more polymer (POLc). The required and preferred characteristics of polymer (POLc) are the same as those described above regarding polymer (POLb). Polymers (POLb) and (POLc) may be the same as each other or may be different. Preferably, the amount of (POLc) in composition (Cc), by weight based on the weight of composition (Cc), is 70% or more; more preferably 80% or more; more preferably 85% or more. Preferably, the amount of (POLc) in composition (Cc), by weight based on the weight of composition (Cc), is 99.9% or less; more preferably 99.5% or less; more preferably 99% or less; more preferably 98% or less; more preferably 95% or less; more preferably 91% or less.

Composition (Cc) additionally contains one or more olefin copolymer. Preferably composition (Cc) contains one or more ethylene copolymer, one or more propylene copolymer, or a mixture thereof. More preferably, composition (Cc) contains one or more ethylene copolymer.

For the olefin copolymer, suitable oxygen-containing comonomers include, for example, vinyl monomers with acid groups, vinyl monomers with ester groups, vinyl acetate, carbon monoxide, and mixtures thereof. Preferred comonomers are vinyl acetate, carbon monoxide, (meth)acrylic acid, substituted and unsubstituted alkyl esters of (meth)acrylic acid, maleic acid, substituted and unsubstituted alkyl mono- and di-esters of maleic acid, and mixtures thereof. More preferred comonomers are vinyl acetate, carbon monoxide, (meth)acrylic acid, glycidyl methacrylate, unsubstituted alkyl esters of (meth)acrylic acid in which the alkyl group has 4 or fewer carbon atoms, maleic acid, unsubstituted alkyl monoesters of maleic acid in which the alkyl group has 4 or fewer carbon atoms, and mixtures thereof. More preferred comonomers are (meth)acrylic acid, unsubstituted alkyl esters of (meth)acrylic acid in which the alkyl group has 2 or fewer carbon atoms, and maleic acid; more preferred are vinyl acetate and acrylic acid.

Preferably the amount of polymerized units of oxygen-containing comomoner in the olefin copolymer is, by weight based on the weight of the olefin copolymer, 2% or more; more preferably 4% or more; more preferably 7% or more. Preferably the amount of polymerized units of oxygen-containing comomoner in the olefin copolymer is, by weight based on the weight of the olefin copolymer, 30% or less.

Preferably, the amount of olefin copolymer in composition (Cc), by weight based on the weight of composition (Cc), is 30% or less; more preferably 20% or less; more preferably 15% or less. Preferably, the amount of olefin copolymer in composition (Cc), by weight based on the weight of composition (Cc), 0.1% or more; more preferably is 0.5% or more; more preferably 1% or more; more preferably 2% or more; more preferably 5% or more; more preferably 9% or more.

Preferably, composition (Cc) contains little or no tackifier. That is, preferably, the amount of tackifier in composition (Cc) is, by weight based on the dry weight of composition (Cc), less than 10%; more preferably 3% or less; more preferably 1% or less; more preferably zero.

It is useful to consider the quantity (SUMc), defined herein as the sum of the weight of polymer (POLc) and the weight of olefin copolymer. Preferably, the ratio of quantity (SUMc) to the total weight of composition (Cc) is 0.6:1 or higher; more preferably 0.8:1 or higher; more preferably 0.9:1 or higher.

The thickness of the layers is characterized by the coat weight, measured in grams per square meter (gsm). It is useful to characterize the total thickness (TOT), which is the sum of the thickness of layer (Lb) plus the thickness of layer (Lc). Preferably, the total thickness (TOT) is 10 gsm or more; more preferably 15 gsm or more. Preferably, the total thickness (TOT) is 50 gsm or less; more preferably 45 gsm or less.

Preferably, the ratio of the thickness of the layer (Lc) to the total thickness (TOT) is 0.02:1 or higher; more preferably 0.05:1 or higher; more preferably 0.08:1 or higher. Preferably, the ratio of the thickness of the layer (Lc) to the total thickness (TOT) is 0.8:1 or lower; more preferably 0.7:1 or lower; more preferably 0.6:1 or lower.

The pressure sensitive article of the present invention may be made by any method. In a preferred method, each of the layers (Lb) and (Lc) is constructed by forming a layer of an aqueous composition and then drying that layer of aqueous composition.

Preferably, layer (Lb) is formed by first providing an aqueous composition (AQb), which contains dispersed particles of acrylic polymer (POLb). Aqueous composition (AQb) may contain additional compounds in addition to water and acrylic polymer (POLb). A preferred method of making aqueous composition (AQb) is to perform aqueous emulsion polymerization to form dispersed particles of aqueous polymer (POLb) in the form of a polymer latex, which can then serve as aqueous composition (AQb). Preferably, the dispersed polymer particles in aqueous composition (AQb) have volume-average diameter of 50 to 750 nanometers. Preferably, the amount of acrylic polymer (POLb) present in aqueous composition (AQb) is, by weight based on the total weight of aqueous composition (AQb), 20% to 55%. Preferably, a layer of aqueous composition (AQb) is applied to a surface of substrate (Sa) and then dried to form the layer (Lb).

Similarly, a preferred method of making layer (Lc) is to provide an appropriate aqueous composition (AQc), which is applied to layer (Lb) and then dried. Preferably aqueous composition (AQc) contains dispersed polymer particles. In some embodiments, the dispersed polymer particles contain both acrylic polymer (POLc) and olefin copolymer. In preferred embodiments, aqueous composition (AQc) contains dispersed particles of acrylic polymer (POLc) and also contains separate dispersed particles of olefin copolymer.

Aqueous dispersion (AQc) may be made by any method. In a preferred method, aqueous emulsion polymerization is performed to produce a latex (herein labeled (AQc1)) of particles of acrylic polymer (POLc) dispersed in an aqueous medium. The necessary and preferred characteristics of aqueous composition (AQc1) are the same as those described above for aqueous composition (AQb). Preferably, a separate aqueous composition (herein labeled (AQc2)) is provided that contains particles of olefin copolymer dispersed in an aqueous medium. Preferably, aqueous compositions (AQc1) and (AQc2) are mixed together to form aqueous composition (AQc). Preferably, a layer of aqueous composition (AQc) is applied to layer (Lb) and then dried to form the layer (Lc).

Preferably, composition (Cc) has the properties of a PSA. Preferably, composition (Cc) has elastic modulus (G′) of 20 kPa or higher over a temperature range that includes the range of 10° C. to 40° C. Preferably, composition (Cc) has elastic modulus (G′) over a temperature range that includes the range of 10° C. to 40° C. of 1,000 kPa or lower; more preferably 500 kPa or lower.

The pressure sensitive article of the present invention may be made by any method. Preferably, the article is made by a method that comprises the following steps:
(A) forming a layer of an aqueous composition (Qb) that contains dispersed particles of the acrylic polymer (POLb) on a first surface,
(B) forming a layer of an aqueous composition (Qc) that contains dispersed particles that contain (i) the acrylic polymer (POLc) and (ii) the olefin copolymer on a second surface,
(C) drying the layer of the aqueous composition (Qb) to form the layer (Lb), and
(D) drying the layer of the aqueous composition (Qc) to form the layer (Lc).

In some embodiments, steps (A) and (B) are both performed, and then steps (C) and (D) are performed simultaneously. In such embodients, a layer (Lb1) of aqueous composition (Cb1) is applied to substrate (Sa) (the first surface) and, while the layer (Lb1) of aqueous composition (Cb1) is still wet, a layer (Lc1) of aqueous composition (Cc1) is applied on top of the layer (Lb1) of aqueous composition (Cb1) (the second surface), and then the entire ensemble is then dried. Among such embodiments, it is preferred that steps (A) and (B) are performed simultaneously. That is, a multilayer coating device is used that simultaneously applies a layer (Lb1) of aqueous composition (Cb1) to substrate (Sa) and also applies a layer (Lc1) of aqueous composition (Cc1) onto the layer (Lb1) of aqueous composition (Cb1), and then the entire ensemble is dried. One suitable coating device is a slide coater. A slide coater forms a liquid composite in which there is a layer (Lb1) of aqueous composition (Cb1) underneath a layer (Lc1) of aqueous composition (Ca); while keeping those layers intact, the slide coater applies a layer of the entire composite onto a substrate (Sa) in a way that brings layer (Lb1) into contact with substrate (Sa) and leaves layer (Lc1) in contact with air; then the entire article is dried to remove water from the aqueous compositions.

Also contemplated are embodiments in which the pressure sensitive article is made by a transfer coating method, for example a method that involves making a coating layer of composition (Cc) on a release liner (the second surface), then making a coating layer of composition (Cb) on top of the layer of composition (Cb) (the first surface), then contacting the layer of composition (Cb) with substrate (Sa) (preferably under pressure), and then removing the release liner. In such embodiments, step (B) is performed prior to step (A).

It is contemplated that the pressure sensitive adhesive article of the present invention will be put to use by bringing it into contact with an additional substrate (Sd). It is contemplated that pressure will be applied to bring composition (Cc) and substrate (Sd) into intimate contact and then released. It is contemplated that the result will be a bonded article in which the pressure sensitive adhesive article is still intact and in which composition (Cc) is bonded with substrate (Sd). Substrate (Sd) may be any substance. Preferably, Substrate (Sd) is an olefin polymer, more preferably an olefin polymer that is not an olefin copolymer, as defined above. Preferably, substrate (Sd) has Tg of 50° C. or higher.

The following are examples of the present invention. Operations were performed at room temperature (approximately 23° C.) except where otherwise stated. The materials used were as follows:

| Material | Description | Vendor |
|---|---|---|
| COHESA ™ 3050 dispersion | dispersion of | Honeywell |
| | ethylene/acrylic | company |
| | acid copolymer | |
| ELVAX ™ 220W dispersion | dispersion of | Dow |
| | ethylene/vinyl | Chemical Co. |
| | acetate copolymer | |
| A-2050 dispersion | Dispersion of | |
| | ethylene/acid | |
| | copolymer | |
| TERGITOL ™ 15-S-9 | Surfactant | Dow |
| | | Chemical Co. |
| DISPONIL ™ FES77 | Surfactant | BASF |
| | | company |
| SURFYNOL ™ 440 | Wetting agent | Evonik |
| ACRYSOL ™ RM-2020 | Thickener | Dow |
| | | Chemical Co. |
| Sodium carbonate, ammonium persfulate, tert-butyl | Chemicals | Sinoreagent |
| hydroperoxide, sodium formaldehyde bisulfite, | | company |
| n-dodecyl mercaptan | | |
| 2-ethylhexyl acrylate (EHA), ethyl acrylate, | Monomers | Dow |
| methyl methacrylate acrylic acid | | Chemical Co. |

Experimental EMAA copolymer A-2050 (an EMAA copolymer with MAA content 20% by weight and melt index of 500 g/10 min @ 190° C./21.6 kg per ASTM D1238).

Experimental EMAA copolymer A-2050 may be prepared by standard free-radical copolymerization methods, using high pressure, operating in a continuous manner. Monomers are fed into the reaction mixture in a proportion which relates to the monomer's reactivity, and the amount desired to be incorporated. In this way, uniform, near-random distribution of monomer units along the chain is achieved. Polymerization in this manner is well known and is described for example, in U.S. Pat. No. 4,351,931 (Armitage).

Acrylic polymer emulsion polymerization was conducted as follows. A four liter, five-neck reactor equipped with a condenser, a mechanical stirrer, a temperature-controlled thermocouple and inlets for initiators and monomers, was fed with 540 g of deionized (“DI”) water and heated to 87° C. under a gentle nitrogen flow. In a separate container, a monomer emulsion was prepared by mixing 400 g of DI water, 11.9 g of DISPONIL™ FES77, 5 g of TERGITOL™ 15-S-9, 4 g of sodium carbonate, and 2024 g of a monomer mixture comprising 71.5% of 2-ethylhexyl acrylate (“2-EHA”), 18.5% of ethyl acrylate (“EA”), 9% of methyl methacrylate (“MMA”), and 1% of acrylic acid (“AA”). Next, a solution of a mixture of 1.3 g of sodium carbonate and 7.5 g of ammonium persulfate (“APS”) in 32 g DI water was added into the reactor. Immediately after addition of the solution of Na₂CO₃ and APS, the monomer emulsion was fed into the reactor. The feeding proceeded for 80 minutes. Upon completion of the monomer emulsion addition, the reaction mixture was cooled to 60° C. before gradual addition of a solution of tert-butyl hydroperoxide (70%) (“t-BHP”) (4.7 g in 23 g DI water) and 2.8 g of sodium formaldehyde bisulfite in 28 g DI water, via two separate pipes over 25 minutes. Upon completion of the feeds, the reaction was cooled to room temperature. The obtained composition was then filtered through 325 mesh filter cloth and diluted to 64% solids content to prepare the composition for subsequent evaluation work.

Pressure sensitive adhesive was formulated as follows. All samples were lightly formulated with a wetting agent, such as 0.3% (wet/wet) SURFYNOL™ 440 wetting agent obtained from Air Products (“440”), based on total emulsion, to improve wet-out for lab drawdowns unless otherwise specified. The viscosity was then adjusted to approximately 600 mPa*s (600 cps) (Brookfield, RVDV, 30 rpm, 63#) using a thickener, such as ACRYSOL™ RM-2020 from The Dow Chemical Company, Midland, Mich. (“RM-2020”), and final pH was adjusted to 7.0 to 7.5 using ammonia.

The PSA emulsion was blended with ethylene copolymer dispersion (eg. COHESA™ 3050, ELVAX™ 220 W dispersion, etc.) according to the dosage level (wet weight based on total weight of emulsion) in Tables below under proper agitation.

Lab Drawdowns

Polypropylene (“PP”) film (60 micrometer in thickness) was pre-treated by corona treatment before lamination. The formulated adhesive was coated onto a release paper and dried at 80° C. for 5 minutes. The PP film was laminated with the pressure sensitive adhesive coated release liner.

Performance testing was conducted after the adhesive laminate was conditioned in a controlled environment (22.2 to 23.3° C. (72 to 74° F.), 50% relative humidity) for at least 1 day.

Peel Strength Test: FINAT Test Method No. 1 was followed for peel strength test at 90° on high density polyethylene (HDPE) test plates. FINAT is the European association for the self-adhesive label industry (Laan van Nieuw-Oost Indië 131-G, 2593 BM The Hague, P.O. Box 85612, 2508 CH The Hague, The Netherlands). Before testing, the sample strip was applied to test plate for dwell time of 20 min. All the samples failed as “Adhesive” failure mode.

The results are shown in the tables below.
“C” means comparative, and “I” means inventive.
“Acrylic” refers to the acrylic polymer described above. Number in parentheses refers to the parts based on wet weight of the acrylic polymer latex.
“ECP1” refers to COHESA™ 3050H (active solids of 38.5-41.4%), described above. Number in parentheses refers to the parts based on wet weight of the ECP1 aqueous dispersion.
“ECP2” refers to ELVAX™ 220W dispersion at 40% solids, described above. Number in parentheses refers to the parts based on wet weight of the ECP2 aqueous dispersion.
“ECP3” refers to A-20505 dispersion at 20% solids, described above. Number in parentheses refers to the parts based on wet weight of the ECP3 aqueous dispersion.

“Thick” is the thickness of the total of Layer 1 and Layer 2, in units of gsm (grams of dry composition per square meter)
“ECP Layer” is the dry weight ratio of the layer containing ECP divided by the total dry weight of Layer 1 plus Layer 2, multiplied by 100 (i.e., expressed as a percentage).
“ECP %” is the dry weight of the ECP polymer divided by the sum of the dry weight of Layer 1 plus the dry weight of Layer 2, multiplied by 100 (i.e., expressed as a percentage).
“Peel” is the result of the 90-degree peel test described above, in Newtons (for a sample having width of 2.54 cm (1 inch)).

TABLE 1
Results using ECP1

| | | | | ECP | | |
|---|---|---|---|---|---|---|
| | | | Thick | Layer | ECP | Peel |
| Example | Layer 1 | Layer 2 | (gsm) | (%) | % | (N) |
| C-1 | Acrylic (100) | None | 20 | 100 | 0.62 | 3.3 |
| | ECP1 (1) | | | | | |
| I-1 | Acrylic (100) | Acrylic (100) | 20 | 50 | 0.31 | 3.6 |
| | | ECP1 (1) | | | | |
| C-2 | Acrylic (100) | None | 40 | 100 | 0.62 | 5.5 |
| | ECP1 (1) | | | | | |
| I-2 | Acrylic (100) | Acrylic (100) | 40 | 10 | 0.59 | 6.7 |
| | | ECP1 (10) | | | | |
| C-3 | Acrylic (100) | None | 20 | 100 | 5.88 | 3.8 |
| | ECP1 (10) | | | | | |
| I-3 | Acrylic polymer | Acrylic (100) | 20 | 50 | 2.94 | 4.4 |
| | (100) | ECP1 (10) | | | | |

Comparison of C-1 with I-1: In Example I-1, Layer 2 has the same composition as the total composition of C1 (i.e., 1 part ECP), but in Example I-1, the ECP is only located in Layer 2, and Layer 2 has the same mass as Layer 1. Thus, overall, Example I-1 uses half the amount of ECP used in C-1, and Example I-1 concentrates that ECP into Layer 2, which is in contact with the HDPE test panel. I-1 has better Peel strength than C-1. This demonstrates that locating the ECP in the top layer gives a pressure sensitive article with improved Peel adhesion to HDPE, while using less of the ECP ingredient. It is desirable to obtain the improved Peel adhesion without using unnecessarily large amounts of ECP.

Comparison of C-2 with I-2: Example I-2 has Layer 2 with a relatively high concentration of ECP, but the thickness of Layer 2 is relatively small. Thus I-2 and C-2 have approximately the same total amount of ECP. However, I-2 has far higher peel strength on HDPE, which shows that locating the ECP in the top layer leads to improved performance.

Comparison of C-3 with I-3: This comparison is similar to that described above for comparing C-1 with I-1. That is, I-3 uses half the amount of ECP compared to C-3, but I-3 locates that ECP in the top layer, and improved peel adhesion to HDPE is the result. This comparison remains true for the relatively low overall level of ECP in I-1 and for the relatively high overall level of ECP in I-3.

TABLE 2
Results using ECP2 and ECP3

| | | | | ECP | | |
|---|---|---|---|---|---|---|
| | | | Thick | Layer | ECP | Peel |
| Example | Layer 1 | Layer 2 | (gsm) | (%) | % | (N) |
| C-4 | Acrylic (100) | None | 20 | 100 | 5.88 | 3.6 |
| | ECP2 (10) | | | | | |
| I-4 | Acrylic polymer | Acrylic (100) | 20 | 50 | 2.94 | 4.2 |
| | (100) | ECP2 (10) | | | | |
| C-5 | Acrylic (100) | None | 20 | 100 | 4.19 | 2.9 |
| | ECP3 (14) | | | | | |
| I-5 | Acrylic (100) | Acrylic (100) | 20 | 50 | 2.10 | 3.7 |
| | | ECP3 (14) | | | | |

Comparison of C-4 with I-4: Same as the comparison of C-3 with I-3, but using a different olefin copolymer. That is, even with the different olefin copolymer, higher peel adhesion to HDPE could be achieved with half the amount of olefin copolymer, if the olefin copolymer was located in the top layer.

Comparison of C-5 with I-5: Same as the comparison of C-3 with I-3, but using another different olefin copolymer. That is, even with the third olefin copolymer, higher peel adhesion to HDPE could be achieved with half the amount of olefin copolymer, if the olefin copolymer was located in the top layer.

1. A pressure sensitive adhesive article comprising
(a) a substrate (Sa)
(b) in contact with the substrate (Sa), a layer (Lb) of a pressure sensitive composition (Cb) that comprises one or more acrylic polymer (POLb) having Tg of 20° C. or lower, and
(c) in contact with the layer (Lb), a layer (Lc) that comprises, by weight based on the weight of the layer (Lc),
(i) 60% to 99.5% one or more acrylic polymer (POLc) having Tg of 20° C. or lower, and
(ii) 0.5% to 40% one or more olefin copolymer.

2. The pressure sensitive article of claim 1 wherein the olefin copolymer is an ethylene copolymer.

3. The pressure sensitive article of claim 1 wherein the olefin copolymer comprises polymerized units of vinyl acetate or acrylic acid or a mixture thereof.

4. A method of making the pressure sensitive article of claim 1, wherein the method comprises
(A) forming a layer of an aqueous composition (Qb) that contains dispersed particles of the acrylic polymer (POLb) on a first surface,
(B) forming a layer of an aqueous composition (Qc) that contains dispersed particles that contain (i) the acrylic polymer (POLc) and (ii) the olefin copolymer on a second surface,
(C) drying the layer of the aqueous composition (Qb) to form the layer (Lb), and
(D) drying the layer of the aqueous composition (Qc) to form the layer (Lc).

5. The method of claim 4, wherein aqueous composition (Qb) has been made by a process comprising aqueous emulsion polymerization of one or more monomers to produce dispersed particles of the acrylic polymer (POLb).

6. A bonded article made by a process of contacting a substrate (Sd) with the article of claim 1,wherein the substrate (Sd) is in contact with the layer (Lc).

7. The bonded article of claim 4, wherein the substrate (Sd) is a polyolefin
